(19) United States
(12) Patent Application Publication
(10) Pub. No.: US 2018/0059680 A1
(43) Pub. Date: Mar. 1, 2018

(54) VEHICLE LOCATION RECOGNITION DEVICE

(71) Applicant: DENSO CORPORATION, Kariya-city (JP)

(72) Inventors: Kojiro Tateishi, Kariya-city (JP); Shunsuke Suzuki, Kariya-city (JP); Yusuke Tanaka, Kariya-city (JP)

(21) Appl. No.: 15/688,633

(22) Filed: Aug. 28, 2017

(30) Foreign Application Priority Data
Aug. 29, 2016 (JP) 2016-166938

(51) Int. Cl. G05D 1/02; G01S 17/93; G01S 19/42; G08G 1/16

(52) U.S. Cl. CPC G05D 1/0248; G05D 1/0278; G01S 17/936; G05D 2201/0213; G08G 1/163; G08G 1/166; G08G 1/165; G01S 19/42

(57) ABSTRACT

A vehicle location recognition device has a correction unit for correcting a position of an own vehicle detected by a vehicle position estimation unit. The correction unit corrects the position of the own vehicle so as to reduce a difference in position between a position of a road object detected by a sensor and a position of a map road object contained in map road object information stored in a memory unit. When there are plural combinations of road objects detected by the sensor and map road objects acquired from the map road object information, the correction unit uses a weight value to adjust a likelihood of each of the combinations, and corrects the position of the own vehicle based on the weighted likelihood. The weight value is increased according to increasing of a magnitude of the likelihood.

### CROSS-REFERENCE TO RELATED APPLICATION

This application is related to and claims priority from Japanese Patent Application No. 2016-166938 filed on Aug. 29, 2016, the contents of which are hereby incorporated by reference.

### BACKGROUND OF THE INVENTION

### 1. Field of the invention

The present invention relates to vehicle location recognition devices capable of detecting a location of an own vehicle on a road on which the own vehicle drives, and correcting the location of the own vehicle so as to recognize the location of the own vehicle with high accuracy.

### 2. Description of the Related Art

There is a conventional vehicle location recognition device capable of recognizing a current location of an own vehicle on a road, on which the own vehicle drives. The own vehicle is equipped with the conventional vehicle location recognition device and a global navigation satellite system (GNSS) receiver.

The conventional vehicle location recognition device detects the current location of the own vehicle, and detects a position of each road object which is present around the own vehicle on the basis of detection results of one or more sensors mounted on the own vehicle. For example, there are various types of road objects such as lane boundary lines, road boundary structures, regulation signs or traffic control signs, guide signs, houses, buildings, other vehicles.

The conventional vehicle location recognition device estimates the current position of the own vehicle on the road on the basis of the detected position of the road object and the detected current position of the own vehicle.

Further, the conventional vehicle location recognition device obtains, from map data stored in a map data memory device, road object information of a map road object which is present on the ground or on the road within a detection range of a sensor mounted on the own vehicle. Finally, the conventional vehicle location recognition device corrects the estimated current location of the own vehicle so as to reduce a difference in position between the road object detected by the sensor and the map road object obtained from the object information of the map data.

However, there is a possible case in which the road object on the road detected by the sensor is different from the map road object obtained from the road object information.

### SUMMARY

It is therefore desired to provide a vehicle location recognition device capable of detecting a current location of an own vehicle on a road with high accuracy.

An exemplary embodiment provides a vehicle location recognition device which detects and recognizes a current position of an own vehicle. The vehicle location recognition device is a computer system including a central processing unit. The computer system is configured to provide a vehicle position estimation unit, a road object detection unit, a road object estimation unit, a map road object information acquiring unit, a correction unit and a first likelihood calculation unit.

The vehicle position estimation unit estimates a position of the own vehicle. The road object detection unit detects a detection point of a road object in acquired image data acquired by and transmitted from a sensor mounted on the own vehicle. The road object estimation unit estimates a position of the road object detected by the road object detection unit on the basis of the detection point of the road object detected by the road object detection unit and the position of the own vehicle estimated by the vehicle position estimation unit. The map road object information acquiring unit acquires map road object information from a memory unit which stores the map road object information. The map road information contains at least a position and features of each of map road objects. The map road object information represents each of the map road objects present within a detection range of the road object detection unit. The correction unit corrects the position of the own vehicle estimated by the road object estimation unit so as to reduce a difference between the position of the road object estimated by the road object estimation unit and the position of the map road object contained in the map road object information acquired by the map road object information acquiring unit. The likelihood X calculation unit calculates a likelihood X of similarity between the road object and the map road object in each combination on the basis of the position and features of the map road object. Each combination is composed of the road object detected by the road object detection unit and the map road object in the map road information acquired by the map road object information acquiring unit. The likelihood X represents a degree in similarity between the road object and the map road object in each of the combinations. The correction unit further weights a correction value of each of the combinations so that the correction value increases according to increasing of the likelihood X of the combination, and corrects the position of the own vehicle by using the correction value of each of the combinations.

In the vehicle location recognition device according to the present invention having the improved structure previously described, when there are plural combinations of road objects detected by the road object detection unit and map road objects acquired from the acquired map road object information, the correction unit uses a weight value so as to adjust a likelihood of each of the combinations, and the correction unit corrects the position of the own vehicle based on the weighted likelihood. In particular, the weight value is increased according to increasing of a magnitude of the likelihood. This structure makes it possible to increase the detection accuracy of the position of the own vehicle.

### BRIEF DESCRIPTION OF THE DRAWINGS

A preferred, non-limiting embodiment of the present invention will be described by way of example with reference to the accompanying drawings, in which:

FIG. 1 is a view showing a structure of a vehicle location recognition device according to an exemplary embodiment and other devices mounted on an own vehicle;

FIG. 2 is a view showing a functional structure of the vehicle location recognition device according to the exemplary embodiment shown in FIG. 1;

FIG. 3 is a flow chart showing a drive assist control process executed by the vehicle location recognition device according to the exemplary embodiment shown in FIG. 1;

FIG. 4 is a flow chart showing a process of calculating various likelihoods of a road object, detected by a sensor mounted on the own vehicle, executed by the vehicle location recognition device according to the exemplary embodiment shown in FIG. 1;

FIG. 5 is a view showing an example of a combination of detected road objects and acquired map road objects; and

FIG. 6 is a view showing a block diagram of a functional structure of the vehicle location recognition device having a vehicle state amount acquiring unit according to a modification of the exemplary embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Exemplary Embodiment

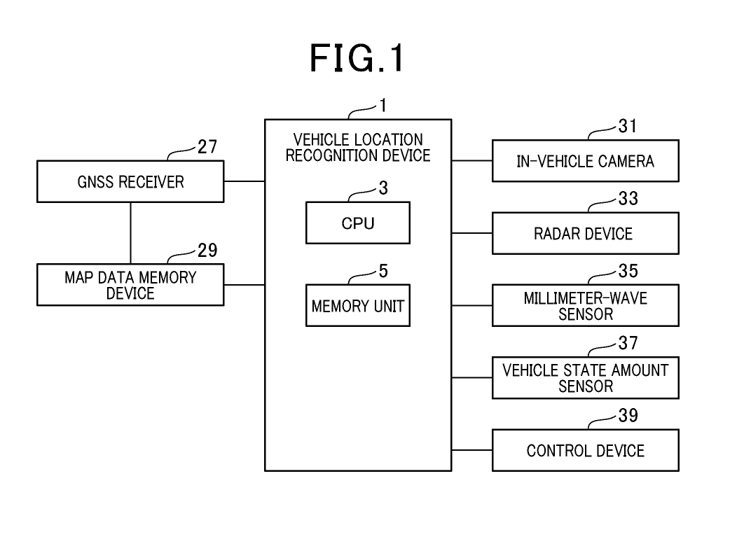

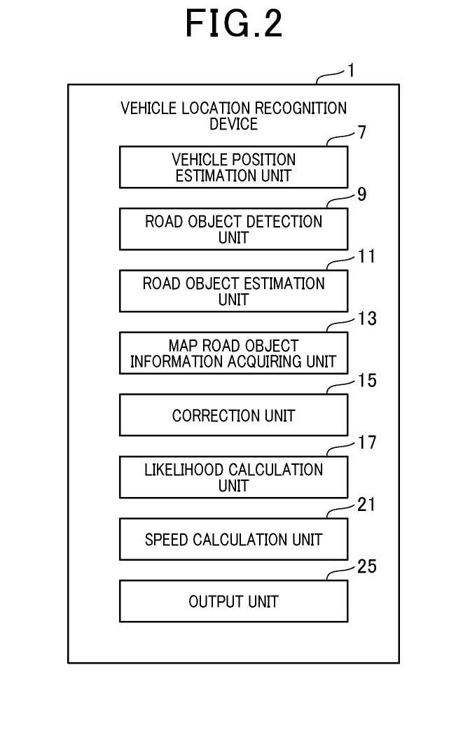

A description will be given of a vehicle location recognition device 1 according to an exemplary embodiment with reference to FIG. 1 to FIG. 6. First, a structure of the vehicle location recognition device 1 will be explained with reference to FIG. 1 and FIG. 2.

FIG. 1 is a view showing the structure of the vehicle location recognition device 1 according to the exemplary embodiment and other devices mounted on an own vehicle. That is, the vehicle location recognition device 1 is mounted on the own vehicle. The vehicle location recognition device 1 is composed of a microcomputer. Such a microcomputer is in general composed of a central processing unit (CPU) 3, a semiconductor memory (hereinafter, referred to as the memory unit 5), etc. The semiconductor memory indicates various types of memories such as random access memories (RAM), read only memories (ROM), flash memories.

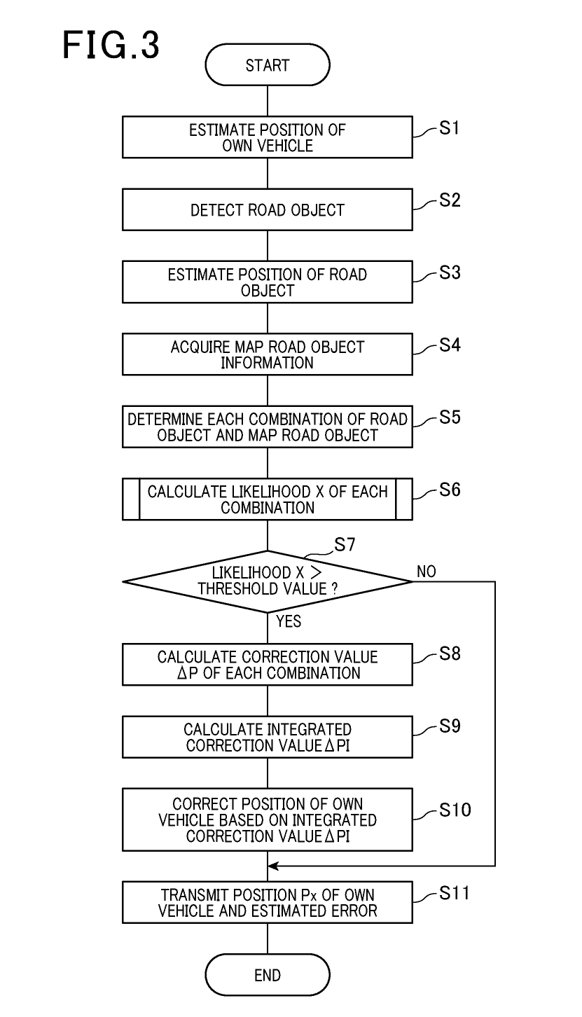

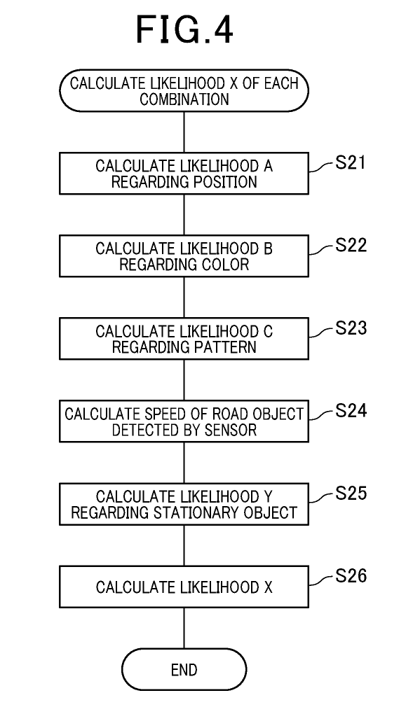

The CPU 3 in the vehicle location recognition device 1 executes programs stored in the memory unit 5 so as to realize, i.e. to execute the functions of the vehicle location recognition device 1. The execution of the programs corresponds to the processes shown in FIG. 2, FIG. 3 and FIG. 4. The processes shown in FIG. 2, FIG. 3 and FIG. 4 will be explained in detail later. It is acceptable for the vehicle location recognition device 1 to have one or more microcomputers so as to realize the various functions thereof.

FIG. 2 is a view showing a functional structure of the vehicle location recognition device 1 according to the exemplary embodiment shown in FIG. 1.

As shown in FIG. 2, the vehicle location recognition device 1 shown in FIG. 1 has the functional structure composed of a vehicle position estimation unit 7, a road object detection unit 9, a road object estimation unit 11, a map road object information acquiring unit 13, a correction unit 15, a likelihood calculation unit 17, a speed calculation unit 21, an output unit 25. The likelihood calculation unit 17 is composed of a first likelihood calculation unit and a second likelihood calculation unit. The first likelihood calculation unit calculates a likelihood X and the second likelihood calculation unit calculates a likelihood Y.

It is acceptable to use one or more hardware units in addition to the software such as programs so as to realize the functional structure of the vehicle location recognition device 1 according to the exemplary embodiment. For example, it is acceptable to use digital circuits or analogue circuits, or a combination of digital circuits and analogue circuits so as to realize the functional structure of the vehicle location recognition device 1 according to the exemplary embodiment.

As shown in FIG. 1, the own vehicle is equipped with a global navigation satellite system (GNSS) receiver 27, a map data memory device 29, an in-vehicle camera 31, a radar device 33, a millimeter-wave sensor 35, a vehicle state amount sensor 37 and a control device 39. The map data memory device 29 corresponds to a memory unit. The in-vehicle camera 31, the radar device 33 and the millimeter-wave sensor 35 correspond to a sensor section mounted on the own vehicle.

The GNSS receiver 27 receives navigation signals transmitted from a plurality of navigation satellites. The map data memory device 29 stores map road object information. The map road object information involves information regarding position, color, pattern, type, size, shape, etc. of each road object. The map road object information such as position, color, pattern, type, size, shape, etc. of a road object correspond to feature of a road object. There are various types of road objects around the own vehicle, such as lane boundary lines, road boundary structures, regulation signs or traffic control signs, guide signs, houses, buildings, other vehicles. At least some of those road objects are stationary objects which do not move on the ground and road.

The in-vehicle camera 31 acquires a forward view in front of the own vehicle, and transmits forward image data to the vehicle location recognition device 1. The radar device 33 and the millimeter-wave sensor 35 detect various types of objects which are present around the own vehicle, and transmit detection results to the vehicle location recognition device 1. The various types of objects, to be detected by the radar device 33 and the millimeter-wave sensor 35, contain road objects on the ground and the road. The vehicle state amount sensor 37 detects a vehicle speed, an acceleration, a yaw rate of the own vehicle, and transmits the detection results to the vehicle location recognition device 1.

The control device 39 executes the drive assist control process by using a vehicle position Px and an estimation error which will be explained in detail later.

### (Process to be Executed by the Vehicle Location Recognition Device 1)

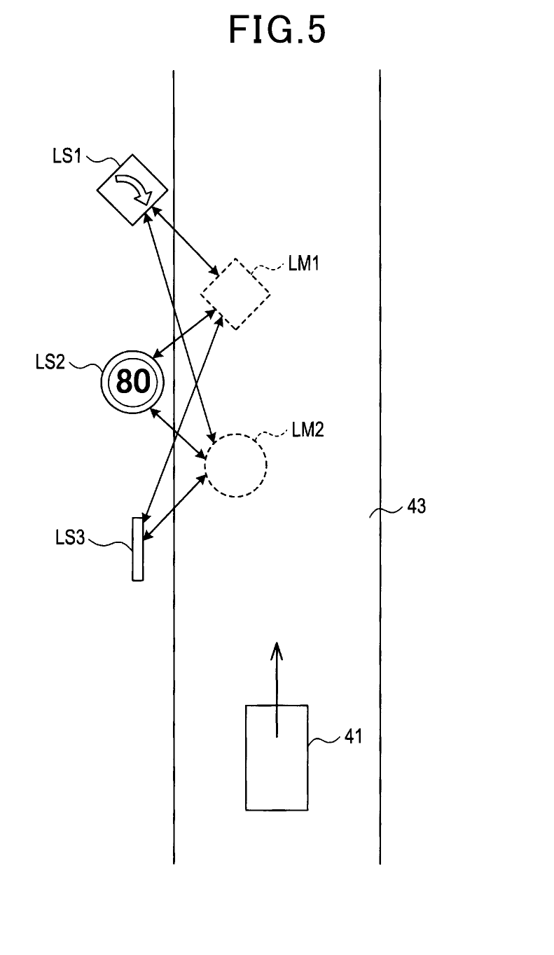

A description will be given of the process which is repeatedly executed at predetermined intervals by the vehicle location recognition device 1 with reference to FIG. 3, FIG. 4 and FIG. 5.

FIG. 3 is a flow chart showing a drive assist control process executed by the vehicle location recognition device 1 according to the exemplary embodiment shown in FIG. 1. FIG. 4 is a flow chart showing a process of calculating various likelihoods of a road object, detected by one or more sensors mounted on the own vehicle, executed by the vehicle location recognition device 1 according to the exemplary embodiment shown in FIG. 1.

In step S1 shown in FIG. 3, the vehicle position estimation unit 7 estimates a vehicle position Pₓ as the current position of the own vehicle on the basis of navigation signals transmitted from the GNSS receiver 27. The GNSS receiver 27 has received those navigation signals transmitted from a plurality of navigation satellites. When the own vehicle drives on the road in an area such as a tunnel in which the GNSS receiver 27 cannot receive navigation signals transmitted from the navigation satellites, the vehicle position estimation unit 7 estimates the vehicle position Pₓ on the basis of a vehicle speed, an acceleration, a yaw rate of the own vehicle, which have been detected by the vehicle state amount sensor 37. The operation flow progresses to step S2.

In step S2, the road object detection unit 9 receives the forward image data regarding the forward view in front of the own vehicle acquired by the in-vehicle camera 31.

The road object detection unit 9 acquires a detection point of each of road objects from the acquired forward image data. The road objects are present on the road on which the own vehicle drives or on the ground around the road. In particular, brightness of such road objects varies with a specific pattern in the acquired forward image data at the detection points of the road objects. For example, when the road object is a lane boundary line, there are plural detection points of the road objects on the lane boundary line, which are higher in brightness than areas around the lane boundary line.

Next, the road object detection unit 9 detects the road object on the basis of the acquired detection points. For example, when the plural detection points are arranged in line on a straight line, the road object detection unit 9 detects the lane boundary line which runs on the detected detection points having high brightness.

Further, the road object detection unit 9 calculates a relative position P_{y} of the detected road object, measured from the position of the own vehicle, on the basis of the detection points in the forward image data. It is acceptable for the relative position P_{y} to be a position in a drive direction of the own vehicle or a position in a lateral direction of the own vehicle. The operation flow progresses to step S3.

In step S3, the road object estimation unit 11 estimates a position P_{L1} of the detected road object on the basis of a combination of the vehicle position Pₓ estimated in step S1 and the relative position P_{y} of the detected road object calculated in step S2. This position P_{L1} of the detected road object is a point on an absolute coordinate system (hereinafter, the fixed coordinate system) on the earth. The operation flow progresses to step S4.

In step S4, the map road object information acquiring unit 13 acquires the map road object information from the map data memory device 29. The map road object information to be acquired corresponding to map road object information which are present within the detection range of the in-vehicle camera 31 at the vehicle position Px of the own vehicle. The operation flow progresses to step S5.

In step S5, the likelihood calculation unit 17 determines a combination of the detected road object obtained in step S2 and the road object (hereinafter, referred to as the map road object) which represents the map road object information acquired in step S4. When there are plural detected road objects and map road objects, the likelihood calculation unit 17 generates a plurality of combinations of the detected road objects and the map road objects.

A description will now be given of a case in which the process in step S2 detects the three road objects LS1, LS2 and LS3, and the process in step S3 acquires two map road objects LM1 and LM2.

FIG. 5 is a view showing a combination of the detected road objects LS1, LS2 and LS3 and the acquired two map road objects LM1 and LM2. That is, FIG. 5 shows the three road objects LS1, LS2 and LS3 which have been detected in step S2 by the sensors mounted on the own vehicle, and two map road objects LM1 and LM2 acquired in step S4. That is, the map road objects LM1 and LM2 correspond to the road objects LS1 and LS2, respectively.

It is possible for the vehicle location recognition device 1 according to the exemplary embodiment to apply the process in step S2 and the process in step S4 shown in FIG. 5 to a case in which the number of detected road objects is not less than three, and the number of the acquired map road objects is not less than two. In FIG. 5, reference number 41 designates the own vehicle equipped with the vehicle location recognition device 1 according to the exemplary embodiment, and reference number 43 represents the road on which the own vehicle 41 is driving.

In the case shown in FIG. 5, there are various combinations, i.e. it is possible to detect plural combinations, for example, a combination of the road object LS1 and the map road object LM1, a combination of the road object LS1 and the map road object LM2, a combination of the road object LS2 and the map road object LM1, a combination of the road object LS2 and the map road object LM2, a combination of the road object LS3 and the map road object LM1, and a combination of the road object LS3 and the map road object LM1, etc.

In step S6 shown in FIG. 3, the likelihood calculation unit 17 and the speed calculation unit 21 calculate a likelihood X of each of the combinations. Each combination is composed of the road object and the map road object determined in step S5. That is, this likelihood X of the combination represents a degree of identification, i.e. degree of similarity between the road object and the map road object in each of the combinations. For example, in the case shown in FIG. 5, the likelihood X of the combination of the road object LS1 and the map road object LM1 represents a degree of similarity between the road object LS1 and the map road object LM1.

A description will now be given of the method of calculating the likelihood X of each combination composed of road object and map road object with reference to FIG. 4.

The vehicle location recognition device 1 according to the exemplary embodiment executes the process from step S21 to step S26 every combination of road objects and map road objects. In step S21 shown in FIG. 4, the likelihood calculation unit 17 calculates a likelihood A represents a distance between the position of the detected road object and the acquired map road object. The likelihood A increases according to reducing of the distance between the detected road object and the acquired map road object.

It is acceptable to detect the position of a road object on the basis of one of: a forward position or a back position viewed from the own vehicle; a position in a wide direction of the own vehicle; a position in height measured from the ground (i.e. the road surface); and a position in height measured from the own vehicle.

Reference character P_{L1} represents the position of the road object detected by the sensors such as the radar device 33 and the millimeter-wave sensor 35. The map road object information contain the information regarding the position of the map road object. The operation flow progresses to step S22.

In step S22, the likelihood calculation unit 17 calculates a likelihood B representing a degree of similarity in color between the detected road object and the acquired map road object. The likelihood B increases according to increasing the degree of similarity in color between the road object detected by the sensor and the acquired map road object. It is possible for the likelihood calculation unit 17 to acquire color information of the detected road object from the front image data transmitted from the in-vehicle camera 31. The map road object information acquired in step S4 contains color information of the map road object. The operation flow progresses to step S23.

In step S23, the likelihood calculation unit 17 calculates a likelihood C representing a degree of similarity in pattern between the detected road object and the acquired map road object. The likelihood C increases according to increasing of the degree of similarity in pattern between the road object detected by the sensors and the acquired map road object. It is possible for the likelihood calculation unit 17 to acquire pattern information of the detected road object from the front image data transmitted from the in-vehicle camera 31. The map road object information acquired in step S4 contains pattern information of the map road object. The operation flow progresses to step S24.

In step S24, the speed calculation unit 21 calculates a speed of the detected road object in a fixed coordinate system by the following method. The speed calculation unit 21 calculates a relative speed of the detected road object to the own vehicle on the basis of a change in position of the detected road object in the front image data acquired by the sensors. The speed calculation unit 21 further calculates a speed of the own vehicle on the basis of the detection results of the vehicle state amount sensor 37. Finally, the speed calculation unit 21 calculates the speed of the detected road object in the fixed coordinate system on the basis of the relative speed of the detected road object and the vehicle speed of the own vehicle. The operation flow progresses to step S25.

In step S25, the likelihood calculation unit 17 calculates a likelihood Y of the detected road object on the basis of the speed of the detected road object in the fixed coordinate system calculated in step S24. The likelihood Y of the detected road object represents a degree whether the detected road object is a stationary object which does not move on the ground. The likelihood Y increases according to reducing of the speed of the detected road object in the fixed coordinate system. The operation flow progresses to step S26.

In step S26, the likelihood calculation unit 17 calculates the likelihood X by integrating the likelihood A obtained in step S21, the likelihood B obtained in step S22, the likelihood C obtained in step S23, and the likelihood Y obtained in step S25. It is possible for the likelihood calculation unit 17 to use Bayes' theorem for integrating these likelihoods so as to calculate the likelihood X.

In step S7 shown in FIG. 3, the correction unit 15 checks whether there is at least one combination which has the likelihood X of more than a predetermined reference value.

When the detection result in step S7 indicates affirmation (“YES” in step S7), i.e. indicates that at least one combination has the likelihood X of more than the predetermined reference value, the operation flow progresses to step S8.

On the other hand, when the detection result in step S7 indicates negation (“NO” in step S7), i.e. indicates that no combination has the likelihood X of more than the predetermined reference value, the operation flow progresses to step S11.

In step S8, the correction unit 15 calculates a correction value ΔP of each combination composed of the detected road objects and the acquired map road objects. The correction unit 15 adjusts, i.e. corrects the vehicle position Pₓ estimated in step S1 by using the correction value ΔP so as to reduce the difference between the position of the detected road object and a position P_{L2} of the acquired map road object. The position P_{L1} previously described indicates the position of the detected road object. The map road object information acquired in step S4 contains the information regarding the position P_{L2} of the map road object.

For example, the correction unit 15 uses the correction value ΔP of the combination composed of the road object LS1 and the map road object LM1 in the case shown in FIG. 5 so as to reduce the difference between the position of the road object LS1 and the map road object LM1 and to adjust the vehicle position Pₓ estimated in step S1.

Similar to this, the correction unit 15 further calculates a correction value ΔP of each of the combinations such as the combination of the combination of the road object LS1 and the map road object LM2, the combination of the road object LS2 and the map road object LM1, the combination of the road object LS2 and the map road object LM2, the combination of the road object LS3 and the map road object LM1, and the combination of the road object LS3 and the map road object LM1. The operation flow progresses to step S9.

In step S9, the correction unit 15 integrates the correction value ΔP of each of the combinations calculated in step S8 and calculates an integrated correction value ΔPI by using the likelihood X of each of the combinations. That is, the integrated correction value ΔPI is obtained by a weighting process, i.e. by multiplying the correction value ΔP of each combination and the corresponding likelihood X of each combination together and integrating the results of the weighting process. The operation flow progresses to step S10.

In step S10, the correction unit 15 corrects the vehicle position Pₓ of the own vehicle estimated in step S1 on the basis of the integrated correction value ΔPI calculated in step S9. The operation flow progresses to step S11.

In step S11, the output unit 25 transmits the vehicle position Pₓ of the own vehicle and the estimated error to the control device 39. When the correction unit 15 has corrected the vehicle position Pₓ of the own vehicle in step S10, the output unit 25 transmits the corrected vehicle position Pₓ of the own vehicle and the estimated error to the control device 39.

On the other hand, when the detection result in step S7 indicates negation (“NO” in step S7), and the correction unit 15 has not corrected the vehicle position Pₓ of the own vehicle in step S10, the output unit 25 transmits the vehicle position Pₓ of the own vehicle estimated in step S1 and the estimated error to the control device 39.

### <Effects of the Vehicle Location Recognition Device 1 of the Exemplary Embodiment>

(1A) The vehicle location recognition device 1 calculates the likelihood X of each of the combinations as previously described. Further, the vehicle location recognition device 1 integrates the correction value ΔP of each of the combinations to obtain the integrated correction value ΔPI. The vehicle location recognition device 1 corrects the vehicle position Pₓ of the own vehicle on the basis of the integrated correction value ΔPI. In particular, the greater the likelihood X of the combination is, the larger the magnitude of the weight of the correction value ΔP of the combination is.

That is, when there are plural combinations of detected road objects and acquired map road objects, the vehicle location recognition device 1 weights the likelihood X of each combination and integrates the weighted likelihood of each combination, and corrects the vehicle position Pₓ of the own vehicle on the basis of the integrated value of the weighted likelihoods of the combinations. The greater the likelihood X of the combination of detected road objects and acquired map road objects is, the larger the weight value to be applied to the combination becomes.

For this reason, it is possible to prevent the vehicle location recognition device 1 from using a combination of a detected road object and an acquired map road object which do not represent the same object on the ground, and from adjusting, i.e. correcting the vehicle location of the own vehicle on the basis of such a combination. As a result, it is possible for the vehicle location recognition device 1 to increase the detection accuracy of the vehicle position Pₓ of the own vehicle.

(1B) The vehicle location recognition device 1 calculates the likelihood A regarding position, the likelihood B regarding color, and the likelihood C regarding pattern, and integrates the calculated likelihoods A, B and C to obtain the integrated likelihood X. Accordingly, this makes it possible to calculate the likelihood X of a target road object with high accuracy, and to recognize the vehicle position Pₓ of the own vehicle with high accuracy.
(1C) The vehicle location recognition device 1 calculates the likelihood of each of features, and integrates the calculated likelihoods to obtain the likelihood X of the combination composed of the detected road object and the acquired map road object. Accordingly, this makes it possible for the vehicle location recognition device 1 to calculate the likelihood X of the road object with high accuracy.
(1D) The vehicle location recognition device 1 calculates the likelihood Y of a road object. The likelihood Y represents a degree of the road object to be a stationary object. The vehicle location recognition device 1 calculates the likelihood X by using the likelihood Y. The greater the likelihood Y is, the greater the likelihood X. Accordingly, this makes it possible for the vehicle location recognition device 1 to calculate the likelihood X with more higher accuracy.
(1E) When there is no combination which exceeds the predetermined reference value, the vehicle location recognition device 1 does not calculate the vehicle position Px of the own vehicle. This makes it possible to suppress the vehicle location recognition device 1 from executing incorrect correction of the vehicle position of the own vehicle.

### (Other Modifications)

The concept of the vehicle location recognition device 1 according to the present invention is not limited by the exemplary embodiment previously described. It is acceptable for the vehicle location recognition device 1 to have various modifications.

(1) It is acceptable for the vehicle location recognition device 1 to have a state amount acquiring unit 45.

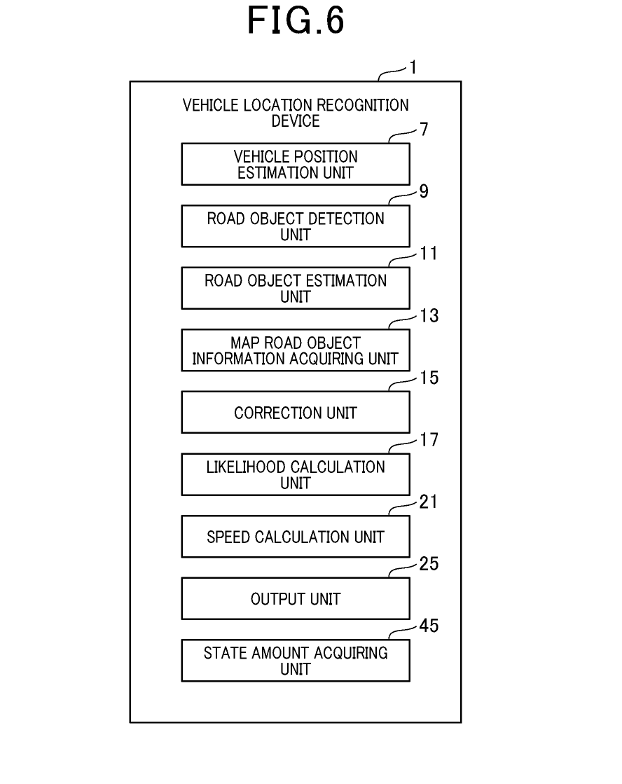

FIG. 6 is a view showing a block diagram of a functional structure of the vehicle location recognition device 1 having the state amount acquiring unit 45 according to a modification of the exemplary embodiment shown in FIG. 1.

As shown in FIG. 6, the vehicle location recognition device 1 further has the state amount acquiring unit 45 in addition to the units 7, 9, 11, 13, 15, 17, 21 and 25 shown in FIG. 1. For example, there are various state amounts such as a degree of a slope of a road, a magnitude of a curvature of a road, and a magnitude of the estimated error of the vehicle position Px of the own vehicle estimated in step S1. It is acceptable for the vehicle location recognition device 1 to acquire those vehicle state amounts from the map road object information stored in the map data memory device, or to receive detection signals representing those vehicle state amounts transmitted from various sensors mounted on the own vehicle.

It is possible for the vehicle location recognition device 1 according to the exemplary embodiment to avoid using the obtained features corresponding to the state amount in the calculation of the likelihood X in step S6 when the obtained state amount value is not less than a predetermined threshold value.

For example, it is possible for the vehicle location recognition device 1 to use a degree of a slope of a road and a height of a road object as a correspondence between the state amount and a feature amount value. The feature amount value represents the feature corresponding to the state amount. When the degree of a slope acquired by the state amount acquiring unit is not less than a predetermined threshold value, it is possible for the vehicle location recognition device 1 to avoid using the likelihood regarding the height of the road object in the calculation of the likelihood X

When the slope of the road is large, the detection accuracy of the height of a road object on the road is reduced, and the likelihood regarding the height of the road object is also reduced. When the degree of the slope of the road obtained by the state amount acquiring unit 45 is not less than the predetermined threshold value, it is possible for the vehicle location recognition device 1 to avoid using the likelihood regarding the height of the road object, and to avoid the calculation of the incorrect likelihood X.

Further, it is possible for the vehicle location recognition device 1 to use a degree of a curvature of a road and a position in the width direction of the own vehicle as another correspondence between the state amount and the feature amount value. When the degree of a curvature acquired by the state amount acquiring unit is not less than a predetermined threshold value, it is possible for the vehicle location recognition device 1 to avoid using the likelihood regarding the position in the width direction of the own vehicle in the calculation of the likelihood X.

When the curvature of the road is large, the detection accuracy of the position in the width direction of the own vehicle is reduced, and the likelihood regarding the position in the width direction of the own vehicle is also reduced. When the magnitude of the curvature of the road obtained by the state amount acquiring unit 45 is not less than the predetermined threshold value, it is possible for the vehicle location recognition device 1 to avoid using the likelihood regarding the position in the width direction of the own vehicle, and to avoid the calculation of the incorrect likelihood X.

Still further, it is possible for the vehicle location recognition device 1 to use the estimated error of the position of the own vehicle obtained in step S1 and a position of a road object in a direction to which the influence of the estimated error becomes large as another correspondence between the state amount and the feature amount value. For example, When the magnitude of the estimated error of the position of the own vehicle obtained by the state amount acquiring unit is not less than a predetermined threshold value, it is possible for the vehicle location recognition device 1 to avoid using the likelihood regarding the position in the direction to which the influence of the estimated error becomes large in the calculation of the likelihood X. This makes it possible to avoid the calculation of the incorrect likelihood X.

(2) It is not necessary for the vehicle location recognition device 1 to obtain all of combinations of detected road objects and acquired map road objects in step S5. For example, it is possible for the vehicle location recognition device 1 to avoid using a combination of road objects and map road objects when a distance between the position of a road object detected by the sensor and the position of the map road object is not less than a predetermined threshold value.
(3) It is not necessary for the vehicle location recognition device 1 to calculate the corrected values ΔP of all of combinations of detected road objects and acquired map road objects in step S8. For example, it is possible for the vehicle location recognition device 1 to avoid calculating the corrected value ΔP of the combination in which the likelihood X is not more than the threshold value.
(4) Further, it is not necessary for the vehicle location recognition device 1 to integrate the corrected values ΔP of all of combinations of detected road objects and acquired map road objects in step S9. For example, it is possible for the vehicle location recognition device 1 to avoid integrating the corrected value ΔP of the combination having the likelihood X of not more than the threshold value.
(5) It is acceptable to detect road objects on the ground and a road by using devices other than the in-vehicle camera 31. For example, it is possible for the vehicle location recognition device 1 to detect road objects by using the radar device 33 and the millimeter-wave sensor 35. It is also acceptable to select at least two sensors in the in-vehicle camera 31, radar device 33 and the millimeter-wave sensor 35, etc. so as to detect road objects.
(6) It is acceptable to use the map data memory device 29 mounted on devices other than the own vehicle. For example, it is acceptable for the vehicle location recognition device 1 to use wireless communication to receive road object information transmitted from the map data memory device 29 mounted on a device other than the own vehicle.
(7) It is acceptable for the vehicle location recognition device 1 to detect in step S7 whether there is a combination having the integrated likelihood X which exceeds a threshold value.
(8) While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.
(9) It is possible to realize the subject matter of the vehicle location recognition device 1 previously described, a system equipped with the vehicle location recognition device 1, a method of executing the functions of the vehicle location recognition device 1 by using programs and/or a non-transitory computer readable storage medium for storing those programs for causing a central processing unit to execute the functions of the vehicle location recognition device 1.

What is claimed is:

1. A vehicle location recognition device 1 for detecting and recognizing a current position of an own vehicle, using a computer system including a central processing unit, the computer system being configured to provide:
a vehicle position estimation unit which estimates a position of the own vehicle;
a road object detection unit which detects a detection point of a road object in acquired image data acquired by and transmitted from a sensor mounted on the own vehicle;
a road object estimation unit which estimates a position of the road object detected by the road object detection unit on the basis of the detection point of the road object and the position of the own vehicle;
a map road object information acquiring unit which acquires map road object information from a memory unit, the memory unit storing the map road object information, the map road information containing at least position and features of each of map road objects, the map road object information representing each of the map road objects which being present within a detection range of the road object detection unit;
a correction unit which corrects the position of the own vehicle estimated by the road object estimation unit so as to reduce a difference between the position of the road object estimated by the road object estimation unit and the position of the map road object contained in the acquired map road object information; and
a first likelihood calculation unit which calculates a likelihood X of similarity between the road object and the map road object in each of combinations on the basis of the position and features of the map road object, each of the combinations being composed of the road object detected by the road object detection unit and the map road object in the map road information acquired by the map road object information acquiring unit, and the likelihood X representing a degree in similarity between the road object and the map road object in each of the combinations, wherein
the correction unit weights a correction value of each of the combinations so that the correction value increases according to increasing of the likelihood X of the combination, and corrects the position of the own vehicle by using the correction value of each of the combinations.

2. The vehicle location recognition device according to claim 1, wherein the map road object information acquiring unit acquires map road object information from the memory unit, the map road information containing, as the features of the map road object, at least one feature selected from a position, a color, and a pattern of the map road object.

3. The vehicle location recognition device according to claim 1, wherein the first likelihood calculation unit calculates a likelihood of each of the features of the map road object, and integrates the calculated likelihoods of the features of the map road object, and calculates the likelihood X of the combination on the basis of the integrated value of the calculated likelihoods.

4. The vehicle location recognition device according to claim 2, wherein the first likelihood calculation unit calculates a likelihood of each of the features of the map road object, and integrates the calculated likelihoods of the features of the map road object, and calculates the likelihood X of the combination on the basis of the integrated value of the calculated likelihoods.

5. The vehicle location recognition device according to claim 3, further comprising a state amount acquiring unit which acquires a state amount, the state amount represents one of a magnitude of a slope of the road on which the own vehicle drives, a magnitude of a curvature of the road, and an estimation error of the position of the own vehicle detected by the vehicle position estimation unit,
wherein when the state amount acquired by the state amount acquiring unit is not less than a threshold value, the first likelihood calculation unit avoids using the feature, which corresponds to the state amount of not less than the threshold value, in the calculation of the likelihood X of the combinations.

6. The vehicle location recognition device according to claim 4, further comprising a state amount acquiring unit which acquires a state amount, the state amount represents one of a magnitude of a slope of the road on which the own vehicle drives, a magnitude of a curvature of the road, and an estimation error of the position of the own vehicle detected by the vehicle position estimation unit,
wherein when the state amount acquired by the state amount acquiring unit is not less than a threshold value, the first likelihood calculation unit avoids using the feature, which corresponds to the state amount of not less than the threshold value, in the calculation of the likelihood X of the combinations.

7. The vehicle location recognition device according to claim 1, further comprising:
a speed calculation unit which calculates a speed in a fixed coordinate system of the road object detected by the road object detection unit; and
a second likelihood calculation unit which calculates a likelihood Y which represents a degree of moving of the road object detected by the road object detection unit so that the likelihood Y increases according to reducing the speed of the road object calculated by the speed calculation unit,
wherein the first likelihood calculation unit calculates the likelihood X of the combination so that the likelihood X increases according to increasing of the likelihood Y.

8. The vehicle location recognition device according to claim 2, further comprising:
a speed calculation unit which calculates a speed in a fixed coordinate system of the road object detected by the road object detection unit; and
a second likelihood calculation unit which calculates a likelihood Y which represents a degree of moving of the road object detected by the road object detection unit so that the likelihood Y increases according to reducing the speed of the road object calculated by the speed calculation unit,
wherein the first likelihood calculation unit calculates the likelihood X of the combination so that the likelihood X increases according to increasing of the likelihood Y.

9. The vehicle location recognition device according to claim 3, further comprising:
a speed calculation unit which calculates a speed in a fixed coordinate system of the road object detected by the road object detection unit; and
a second likelihood calculation unit which calculates a likelihood Y which represents a degree of moving of the road object detected by the road object detection unit so that the likelihood Y increases according to reducing the speed of the road object calculated by the speed calculation unit,
wherein the first likelihood calculation unit calculates the likelihood X of the combination so that the likelihood X increases according to increasing of the likelihood Y.

10. The vehicle location recognition device according to claim 4, further comprising:
a speed calculation unit which calculates a speed in a fixed coordinate system of the road object detected by the road object detection unit; and
a second likelihood calculation unit which calculates a likelihood Y which represents a degree of moving of the road object detected by the road object detection unit so that the likelihood Y increases according to reducing the speed of the road object calculated by the speed calculation unit,
wherein the first likelihood calculation unit calculates the likelihood X of the combination so that the likelihood X increases according to increasing of the likelihood Y.

11. The vehicle location recognition device according to claim 1, wherein the correction unit avoids correcting the position of the own vehicle when there is no likelihood X, calculated by the first likelihood calculation unit, of more than a predetermined reference value.

12. The vehicle location recognition device according to claim 2, wherein the correction unit avoids correcting the position of the own vehicle when there is no likelihood X, calculated by the first likelihood calculation unit, of more than a predetermined reference value.

13. The vehicle location recognition device according to claim 3, wherein the correction unit avoids correcting the position of the own vehicle when there is no likelihood X, calculated by the first likelihood calculation unit, of more than a predetermined reference value.

14. The vehicle location recognition device according to claim 4, wherein the correction unit avoids correcting the position of the own vehicle when there is no likelihood X, calculated by the first likelihood calculation unit, of more than a predetermined reference value.
